(19) United States
(12) Patent Application Publication
(10) Pub. No.: US 2018/0358994 A1
(43) Pub. Date: Dec. 13, 2018

(54) PROTECTIVE CASE AND AN ASSOICATED METHOD OF INSTALLING A SCREEN PROTECTOR ON A CURVE SCREEN

(71) Applicant: Chan Jung Hsu, Taipei (TW)

(72) Inventor: Chan Jung Hsu, Taipei (TW)

(21) Appl. No.: 16/002,997

(22) Filed: Jun. 7, 2018

(30) Foreign Application Priority Data
Jun. 7, 2017 (TW) 106208327

(51) Int. Cl. H04B 1/3888; G06F 1/16

(52) U.S. Cl. CPC H04B 1/3888; A45C 2011/002; G06F 1/1626

(57) ABSTRACT

The present disclosure disclosed a device and a method for installing curved protector on a curved screen. The protective case comprises a screen protector and a body. The body has a first member and a second member. The first member engages the second member that holds the screen protector firmly on the mobile device. The method comprises acts of placing a curved screen protector on a screen of a mobile device; and coupling a first member to a second member to hold the curved screen protector on the mobile device. Therefore, the present disclosure is able to hold the screen protector firmly on the mobile device.

### FIELD OF THE INVENTION

Embodiments of the present disclosure relate to a protective case, and especially toward a case and method that are able to install a screen protector firmly on a curved screen.

### BACKGROUND

For these days, the flat screen for the display of the mobile device is no longer the only option, more and more manufactures are opting for curved screen to enhance better aesthetic look and better holding experience on hands. However, for manufactures of screen protectors, the challenge is how to firmly attach the screen protector on a curve screen, especially to the curvature on the edges of the screen and difficultly of planting glue.

With reference to FIG. 1, FIG. 1 is an exemplary diagram of illustrating a conventional way of planting glue on the curved screen protector. Adhesive layer will not fill completely onto the protector 10, the bubbles and failed attachment often occur at the curved surface edge due to the curvature differences of screen protector 10 and screen 50, and difficulties of planting glue smoothly. Therefore, the glue is generally planted on the intersection of flat surface and curved surface edge. As shown in FIG. 1, the adhesive layer is formed like a frame W on the intersection of flat surface and curved surface edge. The thin frame W attaches to the edge of the curved screen 50. In this manner, the screen will not see any bubble. The protector 10 is able to firmly attach onto the screen 50.

However, above mentioned protector structure still has some drawbacks of following:
1. Bad appearance. Although the adhesive frame existed only at the edge, the glue may still block on visible parts at the edge of the screen.
2. Weak adhesion. The protector detached from the screen easily due to the thin glue frame, especially when a user tries to put on the protective case.
3. Poor touch sensitivity. Since the glue only planted on the edge of the protector, the flat surface of the screen protector forms a hollow portion. The interval between the protector and the screen which influences the touch sensitivity and occurs interference phenomenon known as Newton's rings.
4. Hard to install. The thin adhesive frame must properly places on the edge of the flat surface of the protector. The thin adhesive frame breaks easily when a user tries to adjust the placement of the protector.

Moreover, with reference to FIGS. 2A and 2B, finding a proper the screen protector is not that easy. Making the curved screen protector on the edge is a challenge for almost every manufactures, especially to the curvature tolerance of the screen and the protector. The curvature of each screen may also be different for devices. As shown in FIG. 2A, when the curvature of the screen protector 11 is smaller than the screen 50, the edge of the screen 50 is exposed that the screen protector 11 is unable to protect the screen 50. On the other hand, as shown in FIG. 2B, when the curvature of the screen protector 11 is larger than the screen 50, the edge of the screen protector 11 extrudes outwardly from the curved screen 50 that forms a gap. The gap is not only receiving dirty, but also makes the screen protector peeled off by accident.

### SOME EXEMPLARY EMBODIMENTS

These and other needs are addressed by the present disclosure, wherein an approach being provided for a device and a method that installs a curved screen protector firmly on a curved screen of the mobile device without using glue. The present disclosure solves problems of bad appearance, poor touch sensitivity, difficulties of alignment and edge protection.

According to one aspect of an embodiment of the present disclosure, a protective case is provided comprising of a screen protector and a body. The body has a first member and a second member. The first member engages the second member that holds the screen protector firmly on the mobile device.

According to another aspect of an embodiment of the present disclosure, a method of installing a curved screen protector comprising acts of placing a curved screen protector on a screen of a mobile device; and coupling a first member to a second member to hold the curved screen protector on the mobile device.

Accordingly, the device and the method of the present invention are able to hold the screen protector firmly on the mobile device, which solve problems using glue frame for attachment.

### BRIEF DESCRIPTION OF THE DRAWINGS

The disclosure is illustrated by way of example, and not by way of limitation, in the figures of the accompanying drawings in which like reference numerals refer to similar elements and in which:

FIG. 1 is a diagram of illustrating a conventional curved screen protector planted with glue;

FIG. 2A is a structure diagram of a conventional curved screen protector;

FIG. 2B is a structure diagram of another conventional curved screen protector;

FIG. 3 is a diagram illustrating a protective case in accordance with an embodiment of the present disclosure;

FIG. 4A is a diagram illustrating a cover of the protective case in accordance with an embodiment of the present disclosure;

FIG. 4B is a diagram illustrating a cover of the protective case in accordance with another embodiment of the present disclosure;

FIG. 5 is a diagram illustrating a protective case in accordance with another embodiment of the present disclosure;

FIG. 6 is a diagram illustrating a protective case in accordance with yet another embodiment of the present disclosure;

FIG. 7 is a flow diagram illustrating a method of installing a curved screen protector in accordance with an embodiment of the present disclosure; and

FIG. 8 is a flow diagram illustrating a method of installing a curved screen protector in accordance with another embodiment of the present disclosure.

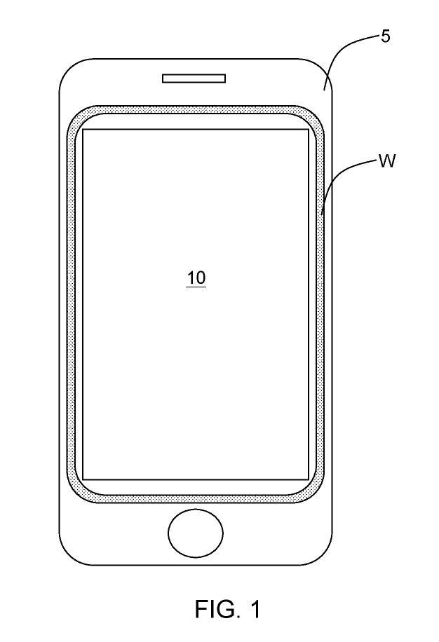

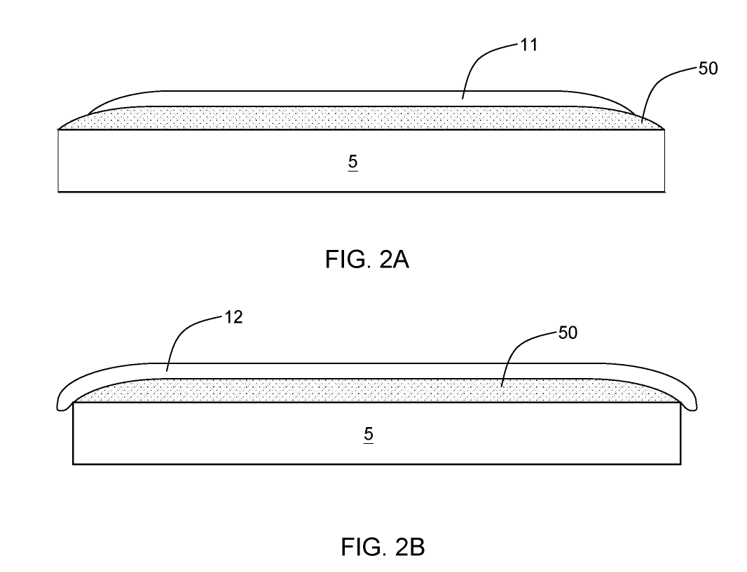

### DESCRIPTION OF THE PREFERRED EMBODIMENT

Embodiments of the apparatus and/or methods are disclosed. In the following description, for purposes of explanation, numerous specific details are set forth in order to provide a thorough understanding of the embodiments of the disclosure. It is apparent, however, to one skilled in the art that the present disclosure may be practiced without these specific details or with an equivalent arrangement.

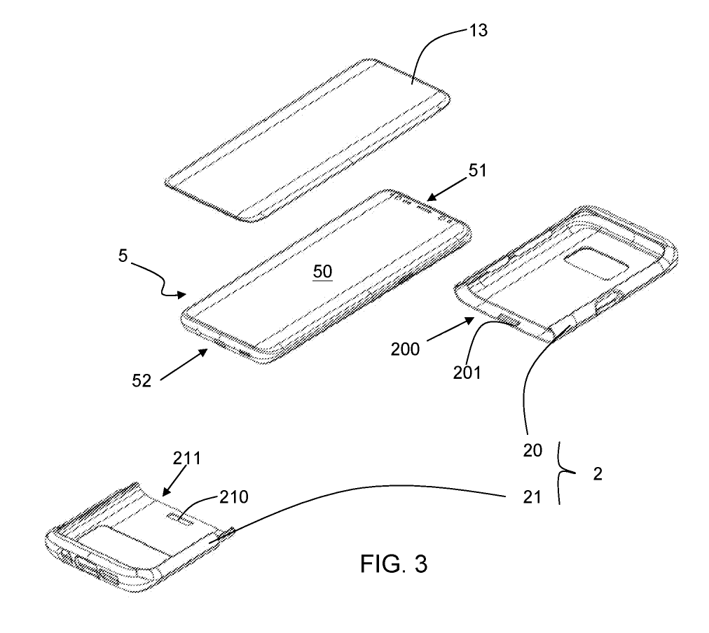

With reference to FIG. 3, FIG. 3 is a diagram illustrating a protective case in accordance with an embodiment of the present disclosure. In this embodiment, the protective case comprises a screen protector 13 and a body 2. The body 2 is two-pieces structure that has a first member 20 and a second member 21. The first member 20 couples to the second member 21 that holds a screen protector 13 firmly on the mobile device 5.

In contrast, the screen protector 13 is not like a conventional screen protector that has an adhesive layer on a surface adhere to the screen 50.

The first member 20 has a first connector 201 formed on a first short edge 200. The second member 21 has a second connector 211 formed on a second short edge 210. The first member 20 and the second member 21 is a slot structure respectively. The first short edge 200 is corresponded to a short edge 51 of the mobile device 5. The second short edge 210 is corresponded to a short edge 52 of the mobile device 5. As shown in FIG. 3, the first member 20 is inserting longitudinally from the top of mobile device 5, and the second member 21 is inserting longitudinally from the bottom of the mobile device 5. The first member 20 and the second member 21 firmly hold the screen protector 13 on the mobile device 5 by connecting the first connector 201 and the second connector 211.

In one embodiment, the first connector 201 is a retention mechanism, and the second connector 211 is a retention receiver.

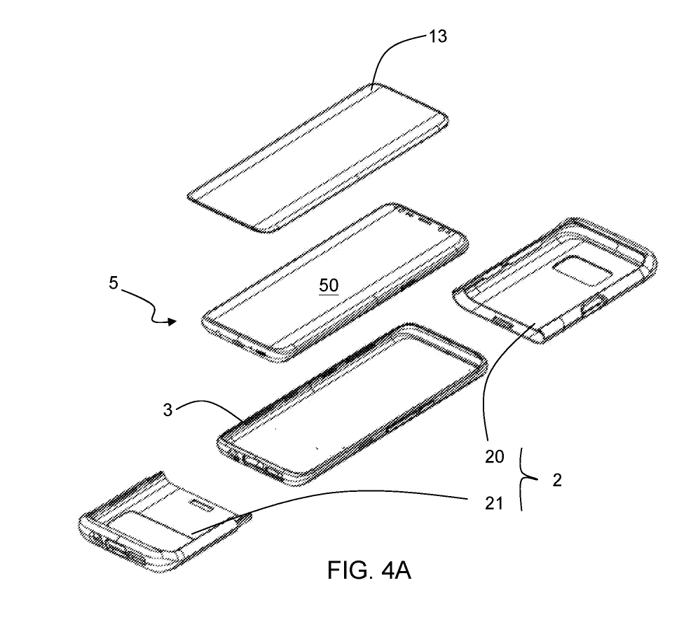

With reference to FIG. 4A, FIG. 4A is a diagram illustrating a cover of the protective case in accordance with an embodiment of the present disclosure. In this embodiment, the protective case further comprises a cover 3. The cover 3 is a soften ring structure substantially surrounded the contour of the mobile device 5, which holds the mobile device 5 inside the cover 3. The cover 3 is able to protect edges of the mobile device 5, and further helps a user aligning the screen protector 13 onto the screen 50 of the mobile device 5. Since the cover 3 is wrapping around the mobile device 5, the user can easily complete the alignment by just placing the screen protector 13 on the contour of the cover 3. The screen protector is firmly held with the cover onto the screen of the mobile device when the first member and second member are engaged.

Since the screen protector 13 of the present invention does not have the adhesive layer, the worry of adhere failure is eased. Furthermore, the manufacturing cost of the screen protector 13 is decreased because the lack of the adhesive layer.

With reference to FIG. 4B, FIG. 4B is a diagram illustrating a cover of the protective case in accordance with another embodiment of the present disclosure. In this embodiment, the cover 3 further comprises a cushioning layer 30 placed on another side corresponded to the screen 50 of the mobile device 5. The cushioning layer 30 acts as a damping overlay that absorbs physical shock externally, which enhances the protection of the mobile device 5.

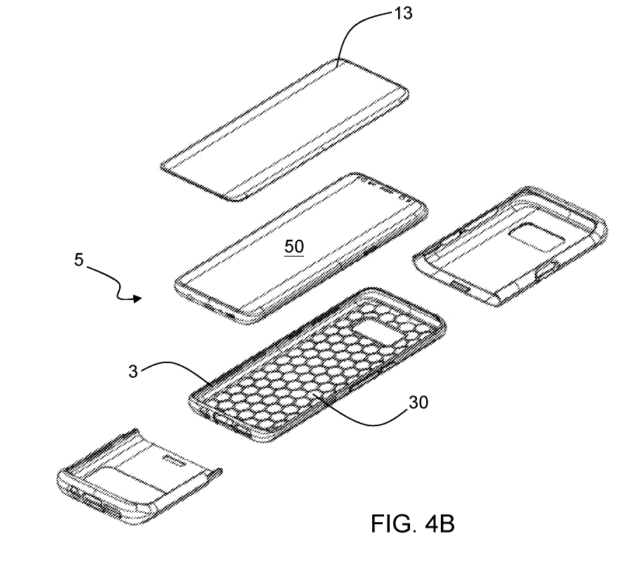

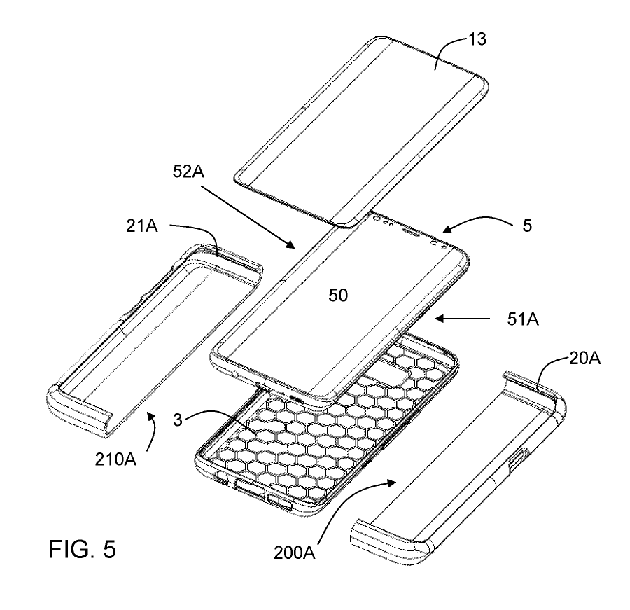

With reference to FIGS. 5 and 6, FIG. 5 is a diagram illustrating a protective case in accordance with another embodiment of the present disclosure, and FIG. 6 is a diagram illustrating a protective case in accordance with yet another embodiment of the present disclosure. The two embodiments provide different structures of engagements compared to the embodiment shown in FIG. 3. As shown in FIG. 5, in this embodiment, the first member 20A has a first connector formed on a first long edge 200A, and the second member 21A has a second connector formed on a second long edge 210A. The first connector connects to the second connector. The first long edge 200A is corresponded to a long edge 51A of the mobile device. The second long edge 210A is corresponded to another long edge 52A of the mobile device. The first member 20A and the second member 21A are engaged latitudinally from the long edges of the mobile device that firmly holds the screen protector 13.

In one embodiment, as shown in FIG. 6, a first connector is formed at the contour of the first member 20B, and a second connector is formed at the contour of the second member 21B. The first connector connects the second connector. The first member 20B is corresponded to a side 51B of the screen 50 of the mobile device 5. The second member 21B is corresponded to another side 52B of the mobile device 5. The first member 20B and the second member 21B are engaged orthogonally from the mobile device 5 that firmly holds the screen protector 13.

It is noted that the first connector and the second connector are not illustrated in FIGS. 5 and 6. A person skilled in art may adapt from the embodiment shown in FIG. 3, which the connectors can be, not limited to, a retention and a retention receiver.

Further, the first member 20, 20A, 20B and the second member 21, 21A, 21B illustrated in FIGS. 3, 5, 6 can also be a frame structure whereby having an opening window or a transparent zone respectively. The frame-like members hold the contour of the screen protector 13, and expose the appearance of the mobile device 5.

Moreover, according to different mobile devices, each of mobile devices has different locations of sockets (e.g., USB port and/or earphone port) or buttons (e.g., volume buttons and/or power button). The first member and the second member further have opening/windows corresponding to such sockets and buttons.

Accordingly, the embodiments above show a novel way to install the screen protector without using any adhesive layer/glue. Anyone is able to make the curved screen protector on the mobile device in a professional manner, especially to the curved screen type devices. The protective case of the present invention avoids problems of adhere failure and imprecise alignment.

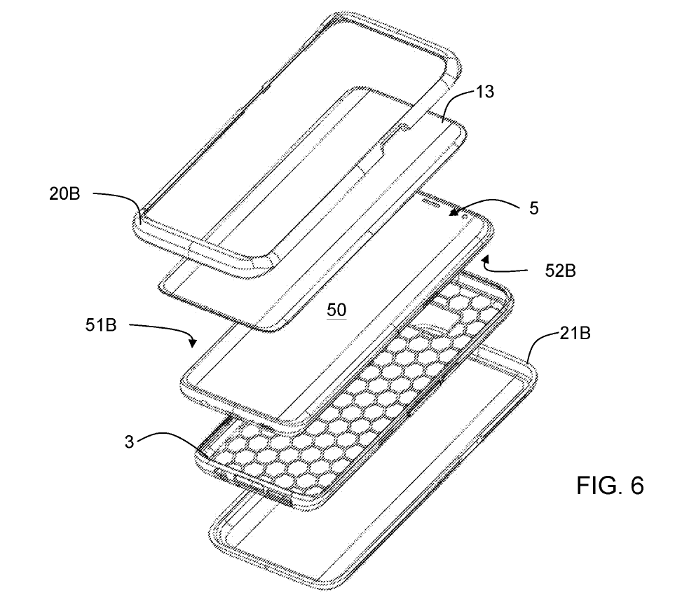

With reference to FIG. 7, FIG. 7 is a flow diagram illustrating a method of installing a curved screen protector in accordance with an embodiment of the present disclosure. In this embodiment, a method of installing a curved screen protector comprising acts of S700 placing a curved screen protector on a screen of a mobile device; and S710 coupling a first member to a second member to hold the curved screen protector on the mobile device.

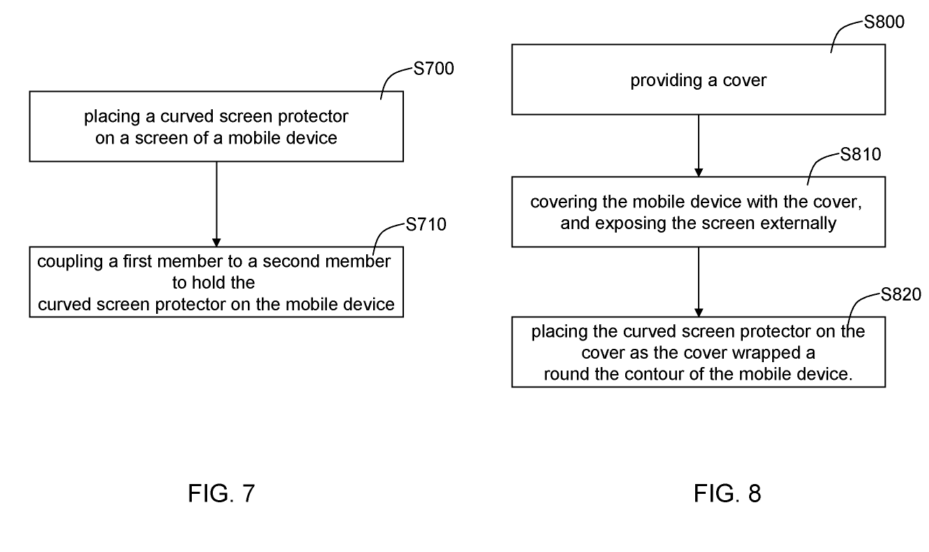

With further reference to FIG. 8, FIG. 8 is a flow diagram illustrating a method of installing a curved screen protector in accordance with another embodiment of the present disclosure. In order to provide better and precise alignment, before placing a curved screen proctor onto the screen, the method further comprises a acts of S800 providing a cover; S810 covering the mobile device with the cover, and exposing the screen externally; and S820 placing the curved screen protector on the cover as the cover wrapped around the contour of the mobile device.

Accordingly, the method of installing a glue-less curved screen protector by two engaged members, which not only solve the problems of glue-type curved screen protectors, and curvature tolerances for curved screen mobile device.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. a protective case comprising:
a screen protector placed on a screen of a mobile device; and
a body having a first member and a second member which are configured to engage that holds the screen protector firmly on the mobile device.

2. The protective case as claimed in claim 1, further comprising a cover substantially surrounded the mobile device and is configured for the screen protector locating on a contour of the cover, which ensures the screen protector to be aligned on the screen of the mobile device.

3. The protective case as claimed in claim 2, wherein the cover further comprises a cushioning layer, and the cushioning layer is placed on another side corresponded to the screen of the mobile device.

4. The protective case as claimed in claim 2, wherein the screen protector is firmly held with the cover onto the screen of the mobile device when the first member and second member are engaged.

5. The protective case as claimed in claim 1, wherein
a first connector formed on a first short edge of the first member, and the first short edge is corresponded to a short edge of the mobile device; and
a second connector formed on a second short edge of the second member, wherein the second short edge is corresponded to another short edge of the mobile device, and is configured for connecting to the first connector.

6. The protective case as claimed in claim 5, wherein the first connector is a retention mechanism, and the second connector is a retention receiver.

7. The protective case as claimed in claim 1, wherein
a first connector formed on a first long edge of the first member, and the first long edge is corresponded to a long edge of the mobile device; and
a second connector formed on a second long edge of the second member, wherein the second long edge is corresponded to an other long edge of the mobile device, and is configured for connecting to the first connector.

8. The protective case as claimed in claim 1, wherein
a first connector formed on a contour of the first member, and the first member is corresponded to a side of a screen of the mobile device; and
a second connector formed on a contour of the second member, wherein the second member is corresponded to another side of the mobile device, and is configured for connecting to the first connector.

9. The protective case as claimed in claim 1, wherein the first member and the second member are frame structure.

10. The protective case as claimed in claim 1, wherein the first member and the second member have an opening window or a transparent zone respectively.

11. A method of installing a curved screen protector comprising acts of:
placing a curved screen protector on a screen of a mobile device; and
coupling a first member to a second member to hold the curved screen protector on the mobile device.

12. The method as claimed in claim 11, further comprising an acts of:
providing a cover;
covering the mobile device with the cover; and
placing the curved screen protector on the cover.
